(19) United States
(12) Patent Application Publication
(10) Pub. No.: US 2007/0263247 A1
(43) Pub. Date: Nov. 15, 2007

(54) Printing Program, Printing Method, and Host Device

(75) Inventor: Takashi Nagai, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 11/619,530

(22) Filed: Jan. 3, 2007

(30) Foreign Application Priority Data
Jan. 6, 2006 (JP) 2006-001337

(51) Int. Cl. G06K 1/00

(52) U.S. Cl. 358/1.15

(57) ABSTRACT

A printing program, which causes a host device to execute a process of saving a printing file, which is printable by a printer, to a removable memory which is attachable with respect to the printer; causes the host device to execute: receiving an operation of dropping an icon, which is displayed on a display section equipped in the host device and represents a print target file to be printed by the printer, onto an icon displayed on the display section and representing saving to the removable memory; processing the print target file, which is subjected to the drop operation, into the printing file; and saving the obtained printing file to the removable memory.

### CROSS-REFERENCE TO RELATED APPLICATIONS

This application is based upon and claims the benefit of priority from the prior Japanese Patent Application No. 2006-001337, filed on Jan. 6, 2006, the entire contents of which are incorporated herein by reference.

### BACKGROUND OF THE INVENTION

1. Field of the Invention

The present invention relates to a printing program and the like for saving a printing file, and particularly to a printing program and the like capable of saving the printing file to a removable memory with an easy operation without causing any errors.

2. Description of the Related Art

Normally, when printing using a printer, printing is requested sent from a host device such as a personal computer connected to the printer via a cable or the like, a printer driver provided in the host device is activated to generate print data, and the print data is transmitted to the printer, whereby printing is performed.

However, various types of removable memories that are detachable with respect to the drives of a computer and the like have become widespread in recent years, and, in association with such spread, printers capable of printing directly from these removable memories have become popular. These printers are equipped with a port into which a removable memory can be inserted, and can print the data on the attached memory by operating an operation panel of the printers.

Therefore, in host devices which generate data as the target of printing, there are host devices which are provided with a function of saving such data to a removable memory in a printable state. For example, “CPS Soft Ripper Plus 2, User Guide, PostScript Software Interpreter” (Seiko Epson Corporation, 2004, pg. 36 and 37) describes a function which saves print target data as a file without printing it immediately. This function is realized as a partial function of a printer driver, wherein a user first specifies saving as a file, thereafter sets the printing conditions, file format and the like, and specifies the destination (folder) to save the file. In response to such operations, the driver processes the print target data into printable data and save the data in a specified place. A removable memory attached to a host device is specified as the destination to save the data, whereby the data is saved to this memory.

Such saving of data to a removable memory and printing of the data on the printer machine side using the memory is performed when the host device and the set position of the printer are separated from each other because the user does not want anybody to see the printed matter, or when the printer that the user wishes to use is not connected to the host device.

However, saving of a file to a removable memory in a host device is realized as a partial function of the driver, thus it was troublesome to perform user operations including opening a file containing print target data by using a predetermined application, requesting a printing, specifying to save them as a file, and specifying a path to the destination.

When specifying a path to the destination to save a file, since the destination is not limited to a removable memory, and the volume to be mounted may differ every time when the removable memory is attached, the operation is relatively troublesome, and errors may occur.

Therefore, the conventional operation of saving a file to a removable memory was not so simple and thus cannot be performed intuitively.

### SUMMARY OF THE INVENTION

An object of the present invention is, therefore, to provide a printing program and the like capable of saving a printing file to a removable memory with an easy operation without causing any errors.

In order to achieve the above object, one aspect of the present invention is a printing program, which causes a host device to execute a process of saving a printing file, which is printable by a printer, to a removable memory which is attachable with respect to the printer; the printing program causing the host device to execute: receiving an operation of dropping an icon, which is displayed on a display section equipped in the host device and represents a print target file to be printed by the printer, onto an icon displayed on the display section and representing saving to the removable memory; processing said print target file, which is subjected to the drop operation, into the printing file; and saving the obtained printing file to the removable memory.

Further, in a preferred aspect in the above invention, the said program further causes the host device to execute, after the receiving, checking whether the host device is attached with the removable memory on which the saving may be performed, and, as a result of the checking, if the host device is attached with the removable memory on which the saving may be performed, the processing and the saving are executed, but if the host device is not attached with the removable memory, an error processing is executed.

In one aspect of the above invention, the icon representing saving to the removable memory corresponds to one predetermined removable memory, the display section displays one or more icons representing saving to the removable memory, and the saving is performed on a removable memory corresponding to the icon which is subjected to the drop operation and represents saving to the removable memory.

Also, in other aspect of the above present invention, as a result of the checking, in the case in which the host device is attached with the removable memory on which the saving may be performed, if the number of attached removable memories on which the saving may be performed is one, the saving is performed on the one removable memory, and if the number of attached removable memories is two or more, the saving is performed on a removable memory selected by a user.

Moreover, in a preferred aspect of the above invention, the checking whether the host device is attached with the removable memory on which the saving may be performed is checking whether the host device is attached with a removable memory whose identification information is previously registered in the host device.

In addition, in other aspect of the above invention, the checking whether the host device is attached with the removable memory on which the saving may be performed is checking whether the host device is attached with the removable memory which is attachable with respect to the printer and with which a printing file to be saved is printable by the printer.

In order to achieve the abovementioned object, another aspect of the present invention is a printing method of saving a printing file to a removable memory by means of a host device, attaching the removable memory to a printer, and printing the printing file saved in the removable memory by means of the printer, the method having: a step in which the host device receives an operation of dropping an icon, which is displayed on a display section equipped in the host device and represents a print target file to be printed by the printer, onto an icon displayed on the display section and representing saving to the removable memory; and a step in which the host device processes the print target file, which is subjected to the drop operation, into the printing file and saves the printing file to the removable memory.

In order to achieve the abovementioned object, yet another aspect of the present invention is a host device which executes a process of saving a printing file, which is printable by a printer, to a removable memory which is attachable with respect to the printer, the host device having: a display section which displays an icon representing saving to the removable memory, and an icon representing a print target file to be printed by the printer; and a processing section which receives an operation of dropping the icon representing the print target file onto the icon representing saving to the removable memory, thereafter processes the print target file, which is subjected to the drop operation, into the printing file, and saves the printing file to the removable memory.

Further objects and features of the present invention will become more apparent from the embodiment of the present invention which is described hereinafter.

### BRIEF DESCRIPTION OF THE DRAWINGS

FIG. 1 is a configuration diagram of a host computer 1 to which the present invention is applied, according to an embodiment;

FIG. 2 is a flowchart showing a setting process of a memory folder 12;

FIG. 3 is a flowchart showing a process of saving a file to a removable memory 3; and

FIGS. 4A and 4B are figures showing a display screen 141 provided by the host computer 1.

### DESCRIPTION OF THE PREFERRED EMBODIMENTS

The embodiments of the present invention are described hereinafter with reference to the drawings. However, such embodiments are not to limit the technical scope of the present invention. It should be noted that in the drawings the same reference numerals or reference codes are used to denote the same or like elements.

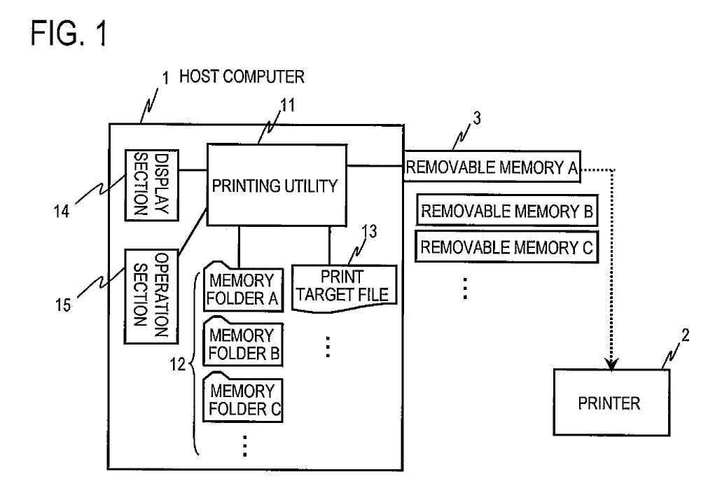

FIG. 1 is a schematic configuration diagram of a host computer as a host device to which the present invention is applied, according to an embodiment. The host computer 1 shown in FIG. 1 is a host device according to the present embodiment, wherein an operation for dropping an icon for a print target file 13 onto an icon for a removable memory 3 is performed on a display screen, thereby the print target file 13 is taken as data which can be printed by a printer 2, and processing for saving the data to the removable memory 3 is executed, and saving of the data for printing to the removable memory is realized with an easy and intuitive operation.

The host computer 1 is constituted by a commonly used personal computer or the like. The removable memory 3 such as a USB memory can be attached to the host computer 1, and data can be read from the attached removable memory 3 and saved to the memory 3. Moreover, the removable memory 3 can also be attached to the printer 2, and data (file) in a predetermined format, which is stored in the attached memory 3, can be printed by performing a user operation on the printer 2. In addition, the printer 2 may or may not be connected to the host computer 1 via a cable or the like.

As shown in FIG. 1, the host computer 1 is equipped with a printing utility 11, memory folder 12, print target file 13, display section 14 and operation section 15. The printing utility 11 has a function of receiving an instruction from a user, performing predetermined processing on the print target file 13 to obtain the print target file 13 as data which can be printed by the printer 2, and saving the data to a specified removable memory 3. The host computer 1 is also characterized in performing the process of saving a file to the removable memory 3, the detailed of which is described hereinafter. It should be noted that the printing utility 11 can be constituted by a program which issues an instruction for a procedure of the process of saving a file into the memory, and a control device or the like which executes processing in accordance with this program. Furthermore, this program corresponds to the printing program in the present embodiment. This program may be installed on the host computer 1 from a CD or other recording media on which it is stored, or may be downloaded to the host computer 1 from a prescribed site via the Internet or another network.

Next, the memory folder 12 is a folder representing each removable memory 3 for saving data (file) which can be printed by the printer 2, and is set by the user before saving the data. In this embodiment, the memory folder 12 and the removable memory 3 correspond one on one to each other. In the example shown in FIG. 1, memory folders A, B and C correspond to removable memories A, B and C respectively. Unique identification information of the corresponding removable memory 3, such as a serial number, vender ID or the like, is stored in the memory folder 12. It should be noted that the memory folder 12 may be linked to the identification information without storing the identification information in the folder itself. Further, this memory folder 12 may not be a folder showing the location of a file, but may be in the form of a file or data. Also, an icon 121 is prepared for each corresponding memory folder 12, and is displayed as an icon to the user by the display section 14.

The print target file 13 is a file which is saved to the removable memory 3 by using the printing utility 11 and thereafter printed by the printer 2. The file may be of any type as long as it can be printed by the printer 2.

Next, the display section 14 is a section for a visual interface to the user, and is constituted by a display screen 141 and the like. Also, the operation section 15 is a section used by the user to operate the host computer 1, and is constituted by a keyboard, mouse, and the like. The display section 14 and operation section 15 are used when the user instructs to save a file to the removable memory 3.

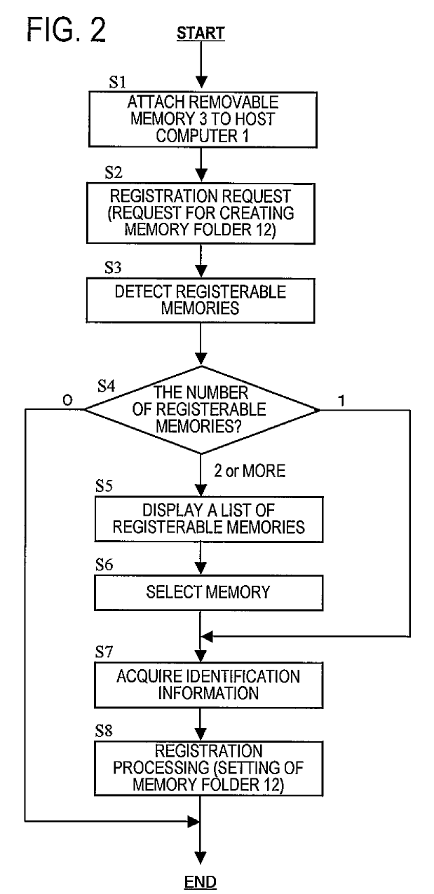

The host computer 1 having the above-described configurations is characterized in saving a file to the removable memory 3 in a manner that the file can be printed by the printer 2, and the process related to this characteristic is described hereinafter in detail. FIG. 2 is a flowchart showing a setting process of the abovementioned memory folder 12. Pre-registration of the removable memory 3 being used to save a file is described first with reference to FIG. 2.

First, the user attaches the removable memories 3 to be registered, to the host computer 1 (step S). Thereafter, the user sends a registration request to the host computer 1 (step S2). Specifically, the user activates the printing utility 11 by, for example, double-clicking on an icon for the printing utility 11, which is displayed on the display screen 141, and requests for creation of the memory folder 12.

In response to this request, the printing utility 11 detects a removable memory 3 which can be registered at this moment (step S3). Specifically, the printing utility 11 detects a removable memory 3 which can be attached to the printer 2, from among the attached removable memories 3.

As a result of the detection, if the number of registerable removable memories 3 is “0” (0 in a step S4), it means that there is no target to be registered, thus the registration processing is ended. If, as a result of the detection, the number of registerable removable memories 3 is “two or more” (“2 or more” in the step S4), a list of the detected registerable removable memories 3 is displayed on the display screen 141 in order to ask the user as to which memory is to be registered (step S5). The user uses the operation section 15 to select a desired removable memory 3 from the list (step S6). Then, the process proceeds to a step S7.

On the other hand, if, as a result of the detection, the number of registerable removable memories 3 is “1” (“1” in the step S4), the registerable memory 3 is determined to be registered, and then the process proceeds to the step S7.

In the step S7, the printing utility 11 acquires identification information of the removable memory 3 which is selected by the user or determined to be registered. Specifically, the printing utility 11 accesses the attached removable memory 3 to acquire the serial number, vendor ID or the like which is the unique identification information of the removable memory 3. Then, a new memory folder 12 having the identification information or associated with the identification information is created (step S8). In other words, a memory folder 12 for the attached removable memory 3 is set, whereby this removable memory 3 is registered. It should be noted that once this registration processing is performed, the icon 121 for the set memory folder 12 is displayed on the display screen 141.

It should be noted that, if the number of registerable removable memories 3 is “two or more” (“2 or more” in the step S4), the identification information of all of the registerable removable memories 3 may be acquired and the registration processing for all of them may be performed, instead of allowing the user to select one removable memory 3. In this case, new memory folders 12 corresponding to the number of registerable removable memories 3 are set.

In the manner described above, pre-registration of the removable memory 3 is performed.

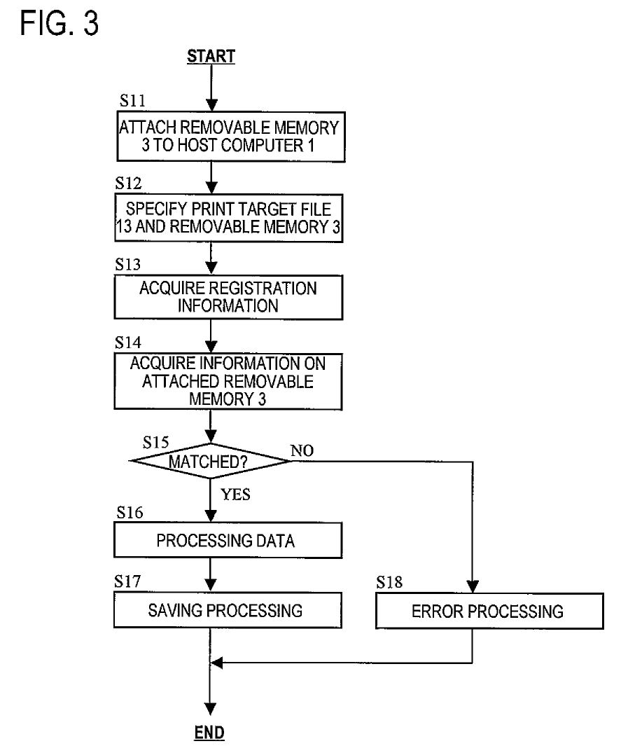

Next, the process of saving a file to the removable memory 3 using the memory folder 12 is explained. FIG. 3 is a flowchart showing the process of saving a file to the removable memory 3. First, the user attaches a removable memory 3 in which the user will save a file that can be printed by the printer 2, to the host computer 1 (step S11). The user then specifies a file as a print target (the print target file 13), which is to be saved to the removable memory 3, and the removable memory 3 (step S12).

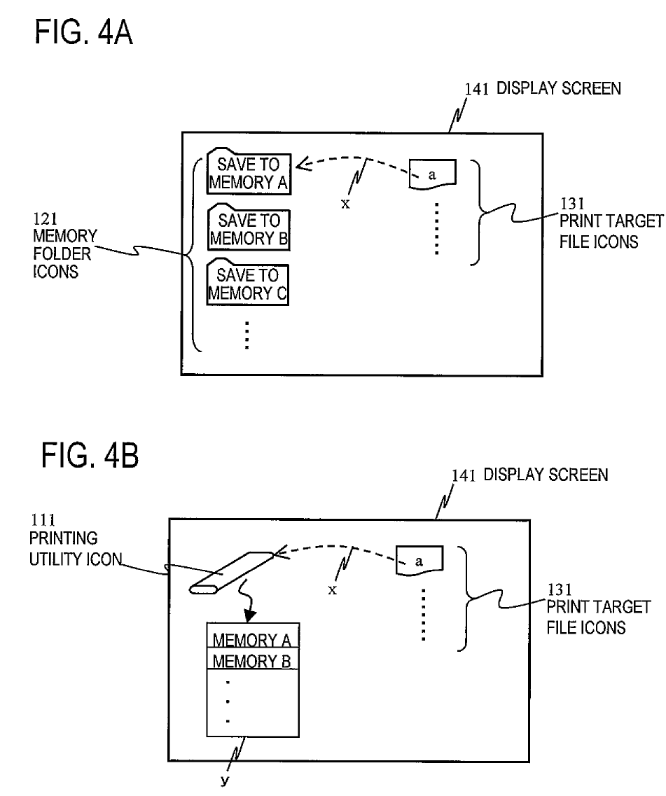

FIGS. 4A and 4B are figures showing the display screen 141 provided by the host computer 1. On the screen shown in FIG. 4A, a plurality of memory folders 12 are iconified and displayed as memory folder icons 121, and the print target file 13 is also iconified and displayed as a print target file icon 131. Here, “save to memory A”, “save to memory B”, and “save to memory C” represented by the memory folder icons 121 correspond to the memory folders A, B, and C respectively shown in FIG. 1, and “a” represented by the print target file icon 131 indicates a certain print target file 13. It should be noted that the shapes or information items of the icons described here are one example, thus the memory folder icons 121 may be any icons as long as they represent predetermined removable memories 3 or file saving with respect to the predetermined removable memories 3. However, it is preferred to use the icons by which the user can intuitively understand that these icons represent the predetermined removable memories 3 or file saving with respect to the predetermined removable memories 3.

The user specifies the print target file 13 and removable memory 3 (S12) by, specifically, performing, on the display screen 141, drop operation of dropping the icon 131 for the print target file 13 to be saved, onto the icon 121 for the memory folder 12 corresponding to the attached removable memory 3. For example, on the display screen 141 in FIG. 4A, the mouse or the like equipped in the operation section 15 is used to move (drag) and drop the print target file icon 131 “a” onto the memory folder icon 121 “save to memory A” (an arrow shown with x in FIG. 4A) By this operation, user instruction is performed for saving the print target file “a” to the removable memory A in the form of a file which can be printed by the printer 2. Therefore, a significant characteristic of the host computer 1 is that, by the series of drag-and-drop operations, the instruction for saving a file to the removable memory 3 by the user can be executed.

In this manner, when the print target file 13 and removable memory 3 are specified, the printing utility 11 acquires registration information on the specified removable memory 3 (step S13). Specifically, the printing utility 11 acquires the identification information of the removable memory 3 which is stored in or associated with the memory folder 12 represented by the memory folder icon 121 on which the icon 131 for the print target file 13 is dropped.

Next, the printing utility 11 acquires the identification information of each removable memory 3 attached to the host computer 1 (step S14). The identification information to be acquired is the information on the same information items as the registered identification information. The printing utility 11 then compares the acquired registration information with the acquired identification information and, if there is an identification information item in the acquired identification information that matches with the acquired registration information (Yes in a step S15), processes the data of the specified print target file 13 (step S16). In this data processing, data conversion, data addition, and other processes are performed so that the data can be printed by the printer 2 directly from the removable memory 3. Thereafter, the printing utility 11 executes a process of saving the processed print target file 13 into the specified removable memory 3 (step S17). In this manner, once the file is saved into the desired removable memory 3, the user can attach this removable memory 3 to the printer 2 to execute printing of the print target file 13.

On the other hand, if there is no information item in the acquired identification information (S14) that matches with the acquired registration information (S13) (No in the step S15), the printing utility 11 performs error processing (step S18). Specifically, the printing utility 11 displays on the display screen 141 a message explaining that the file cannot be saved because the specified removable memory 3 is not attached, and thus does not execute the processing and then saving the file.

Accordingly, the processing of file saving to the removable memory 3 in the host computer 1 is ended.

As described above, in the host computer 1 according to the present embodiment, the removable memories 3 into which a printing file is saved are registered beforehand, and, at the time of file saving, the icon 131 for the file 13 as the target of saving is dropped onto the icon 121 corresponding to each of the registered removable memories 3, whereby the processing of saving to the removable memories 3 is executed. Therefore, the user can save the printing file to a desired removable memory 3 by performing the drag-and-drop operation, and an environment in which the operation can be performed more easily and intuitively than in a prior art is provided. Moreover, the pre-registered removable memory 3 is compared with the actually attached removable memory 3 before performing the saving processing, thus the risk of performing erroneous processing can be reduced.

It should be noted that in the present embodiment the icon 121 for each memory folder 12 is displayed so that the icon and the removable memory 3 correspond one on one to each other, but one icon for saving a printing file to the removable memory 3 may be displayed. FIG. 4B shows the display screen 141 in such a case. A printing utility icon 111 on the screen (an icon for the printing utility 11) is the abovementioned one icon, and the user drops the icon 131 “a” for the print target file to be saved, onto this icon 111.

In response to this drop operation, the printing utility 11 compares the identification information of the registered removable memory 3 with the identification information of the removable memory 3 attached to the host computer 1 at this moment, and, if there is no information item in the identification information that matches with the registered information, executes the error processing. If there is one information item that matches with the registered identification information, the print utility 11 performs the processing of saving to the removable memory 3. If there are two or more information items matching with the registered information, the print utility 11 displays these information items (y in FIG. 4B), allows the user to select a destination for saving, and thereafter performs saving into the selected memory.

In this manner as well, the printing file can be saved into a desired removable memory 3 with an easy and intuitive operation. Furthermore, in the case in which only one removable memory 3 is attached to the host computer 1, the user does not perform the selection processing. Also, since there is one icon as a target of the drop operation, the user operation becomes easier and errors can be further reduced.

Moreover, the memory folder 12 in the above embodiment may not be registered. In such a case, a configuration without the memory folder 12 is obtained in FIG. 1. Then, as shown in FIG. 4B, the printing utility icon 111 showing the printing utility 11 is displayed on the display screen 141. When saving to the removable memory 3, as with the case in which there is one icon described above, the icon 131 “a” for the print target file to be saved is dropped onto this icon.

In response to this drop operation, the printing utility 11 determines, from all removable memories 3 attached to the host computer 1 at that moment, whether or not there is a removable memory 3 which can be attached to the printer 2 to print the data directly from the removable memory 3. As a result of determination, if there is no such removable memory, the printing utility 11 performs the error processing. If there is one such removable memory, the printing utility 11 performs the processing of saving to the removable memory 3, and if there are two or more of such removable memories, these removable memories 3 are displayed (y in FIG. 4B), the user is allowed to select a destination for saving, and the saving processing is performed on the selected memory.

In this alternative idea as well, an icon is provided specifically for the function of saving the printing file to the removable memory 3, and the user may drop the print target file thereon, and thus an environment in which the operation can be performed more easily and intuitively can be provided. Moreover, in this case, pre-registration is not required. Furthermore, since the destination to save is limited to the removable memory 3, the destination to save can be selected from a plurality of destinations more easily than in the prior art, thus errors hardly occur.

The scope of the protection of the present invention is not limited to the above embodiment and thus involves the inventions described in the claims and equivalents thereof.

What is claimed is:

1. A printing program, which causes a host device to execute a process of saving a printing file, which is printable by a printer, to a removable memory which is attachable with respect to the printer;
said printing program causing the host device to execute:
receiving an operation of dropping an icon, which is displayed on a display section equipped in the host device and represents a print target file to be printed by the printer, onto an icon displayed on said display section and representing saving to the removable memory;
processing said print target file, which is subjected to said drop operation, into the printing file; and
saving the obtained printing file to the removable memory.

2. The printing program according to claim 1, wherein said program further causes the host device to execute, after said receiving, checking whether the host device is attached with the removable memory on which said saving may be performed, and, as a result of said checking, if the host device is attached with the removable memory on which said saving may be performed, said processing and said saving are executed, but if the host device is not attached with said removable memory, an error processing is executed.

3. The printing program according to claim 1, wherein said icon representing saving to the removable memory corresponds to one predetermined removable memory, said display section displays one or more icons representing saving to the removable memory, and said saving is performed on are movable memory corresponding to the icon which is subjected to said drop operation and represents saving to the removable memory.

4. The printing program according to claim 2, wherein
as a result of said checking, in the case in which the host device is attached with the removable memory on which said saving may be performed,
if the number of attached removable memories on which said saving may be performed is one, said saving is performed on the one removable memory, and
if said number of attached removable memories is two or more, said saving is performed on a removable memory selected by a user.

5. The printing program according to claim 2, wherein said checking whether the host device is attached with the removable memory on which said saving may be performed is checking whether the host device is attached with a removable memory whose identification information is previously registered in the host device.

6. The printing program according to claim 2, wherein said checking whether the host device is attached with the removable memory on which said saving may be performed is checking whether the host device is attached with the removable memory which is attachable with respect to the printer and with which a printing file to be saved is printable by the printer.

7. A printing method of saving a printing file to a removable memory by means of a host device, attaching said removable memory to a printer, and printing said printing file saved in said removable memory by means of said printer, the method comprising:
a step in which said host device receives an operation of dropping an icon, which is displayed on a display section equipped in said host device and represents a print target file to be printed by the printer, onto an icon displayed on said display section and representing saving to the removable memory; and
a step in which said host device processes said print target file, which is subjected to said drop operation, into said printing file and saves said printing file to the removable memory.

8. A host device which executes a process of saving a printing file, which is printable by a printer, to a removable memory which is attachable with respect to the printer, the host device comprising:
a display section which displays an icon representing saving to the removable memory, and an icon representing a print target file to be printed by the printer; and
a processing section which receives an operation of dropping said icon representing the print target file onto said icon representing saving to the removable memory, thereafter processes the print target file, which is subjected to said drop operation, into the printing file, and saves said printing file to the removable memory.
